(19) United States
(12) Patent Application Publication
(10) Pub. No.: US 2025/0119071 A1
(43) Pub. Date: Apr. 10, 2025

(54) AC-DRIVEN ELECTROSTATIC MACHINE

(71) Applicant: C-Motive Technologies, Inc., Middleton, WI (US)

(72) Inventors: Daniel Colin Ludois, Middleton, WI (US); Peter Davis Killeen, Madison, WI (US); Aditya Nandakumar Ghule, Pune (IN); Justin Kyle Reed, Madison, WI (US)

(21) Appl. No.: 18/906,340

(22) Filed: Oct. 4, 2024

Related U.S. Application Data
(60) Provisional application No. 63/587,876, filed on Oct. 4, 2023.

(51) Int. Cl. H02N 1/00

(52) U.S. Cl. CPC H02N 1/004

(57) ABSTRACT

In one or more arrangements, an electrostatic machine is presented that includes a rotor and a stator. The rotor has a first set of terminals configured to receive a first multiphase AC drive voltage (V_{R}) and the stator has a second set of terminals configured to receive a second multiphase AC drive voltage (V_{S}). When V_{R} is applied to the first set of terminals and V_{S} is applied to the second set of terminals, the rotor and the stator generate respective electric fields which, when properly aligned, cause the rotor to produce torque relative to the stator and induce rotational motion when sufficient torque is generated.

### REFERENCE TO RELATED PATENT APPLICATION(S)

This patent application claims priority to U.S. Provisional Patent Application 63/587,876, filed Oct. 4, 2023, and titled “AC-DRIVEN ELECTROSTATIC MACHINE”, which is hereby fully incorporated by reference herein in its entirety.

### FIELD OF THE DISCLOSURE

This disclosure generally relates to electric-driven machinery. More specifically and without limitation, this disclosure relates to electrostatic machines such as motors, generators, and/or actuators.

### OVERVIEW OF THE DISCLOSURE

Electrostatic machinery such as electric motors, generators, and actuators, convert power between electric and mechanical (e.g., kinetic) forms using electric field torque mechanisms. Electrostatic motors operate by generating movement via interaction of generated electrical fields between a rotor and a stator. Electrostatic motors may be distinguished from conventional electromagnetic machines (commonly referred to as “electric machines”), which exploit forces generated by interacting magnetic fields generated by the stator and rotor (e.g., electrical coils or magnets).

Electrostatic machines may be categorized into general types including but not limited to, for example electrostatic induction machines, variable capacitance/elastance machines, synchronous electrostatic machines, direct current (DC) electrostatic machines, electrostatic hysteresis synchronous machines, and corona machines. In some instances, a particular machine may fall into one or more of such categories. Such categories are not exclusive, and additional categories may exist. The use of such categories is used for explanatory purposes only, and is not meant to be limiting.

Examples of electrostatic machines may be found in: U.S. Pat. No. 9,866,148, titled ELECTROSTATIC MACHINE SYSTEM AND METHOD OF OPERATION and issued Jan. 9, 2018; U.S. Pat. No. 11,114,951, titled ELECTROSTATIC MACHINE SYSTEM AND METHOD OF OPERATION and issued Sep. 7, 2021; U.S. application Ser. No. 17/293,223, titled ELECTROSTATIC MACHINE SYSTEM AND METHOD OF OPERATION and filed May 12,2021; U.S. application Ser. No. 17/141,145, titled ELECTROSTATIC MOTOR and filed Jan. 4, 2021; U.S. Pat. No. 11,742,779, titled ELECTROSTATIC MOTOR HAVING FLUID MANAGEMENT FEATURES and issued Aug. 29, 2023; U.S. application Ser. No. 17/234,463, titled ELECTROSTATIC MOTOR and filed Apr. 19, 2021; U.S. application Ser. No. 17/234,511, titled ELECTROSTATIC MOTOR and filed Apr. 19, 2021; U.S. Pat. No. 11,870,368, titled ELECTROSTATIC MOTOR and issued Jan. 9, 2024; U.S. application Ser. No. 17/234,530, titled ELECTROSTATIC MOTOR and filed Apr. 19, 2021; U.S. application Ser. No. 17/234,539, titled ELECTROSTATIC MOTOR and filed Apr. 19, 2021; U.S. Pat. No. 11,811,334, titled ELECTROSTATIC MOTOR and issued Nov. 7, 2023; U.S. Pat. No. 11,601,069, titled ELECTROSTATIC MACHINES THAT INCLUDE A MALONATE IN A DIELECTRIC FLUID and issued Mar. 7, 2023; U.S. application Ser. No. 18/117,239, titled ELECTROSTATIC MACHINE SYSTEM AND METHOD OF OPERATION and filed Mar. 3, 2023; U.S. application Ser. No. 18/348,010, titled ELECTROSTATIC MOTOR HAVING FLUID MANAGEMENT FEATURES; each of which is incorporated by reference herein in its entirety.

A number of conventional electrostatic machines use opposing sets of capacitive electrodes positioned on plates located in close proximity to one another to create a capacitance between the electrodes and create torque, for example, to facilitate rotational motion. In some designs, the sets of plates can alternate between rotor plates and stator plates. Rotor plates are operably connected to a rotor configured to rotate with a shaft of the motor, generator, and/or actuator and can be analogous to an armature of an induction, wound field, or reluctance motor. Generally, stator plates are operably connected to a stator, which is held in stationary position with respect to a housing or enclosure of the motor and/or generator. The rotor plates and stator plates are positioned in close proximity to one another so that the capacitive electrodes of rotor plates and stator plates are separated by a small gap and form a capacitor. In some implementations, the electrostatic machine may also include a dielectric fluid that fills a void defined by the housing, the rotor electrode, and the stator electrode.

In general, energy storage systems (e.g., capacitors) can naturally store energy based on the arrangement of surfaces and electric potential between them. In the case of variable capacitance machines (and other electrostatic machines), surfaces affixed to a shaft (e.g., rotor plates) can form a capacitance with surfaces affixed to a housing (e.g., stator plates). When voltage is applied to the electrodes of stator plates and/or electrodes of rotor plates, electric fields form on surfaces of the electrodes and induce shear stress between the rotor plates and the stator plates. This shear stress causes repulsive and/or attractive forces between electrodes of stator plates and/or electrodes of rotor plates, thereby generating a rotational force (e.g., torque) between the rotor plates and the stator plates. A sufficiently high total torque on the rotor then causes rotational acceleration, thus causing the rotator to rotate.

Conventional electrostatic machines of this design generate rotational force by applying a DC voltage on electrodes of the rotor plates to generate a DC electric field. This arrangement reduces the complexity of managing capacitive interfaces and permits motion inducing electric fields to be formed by applying an appropriate AC voltage to electrodes of the stator plates, which induces sheer forces and therefore alternating attractive and repulsive forces between the electrodes to produce torque and cause the rotor to rotate. Speed and/or torque are generally increased and/or decreased by adjusting the frequency and/or amplitude of the AC voltage applied to the electrodes of the stator plates. Alternatively, DC voltage may be applied to the electrodes of the stator plates and AC voltage may be applied to electrodes of the rotor plates in a similar manner.

Electrostatic machines may provide a number of benefits over magnetic induction-based electric machines such as: low loss torque at low speeds, and/or lower cost of materials (e.g., in comparison to magnets and windings of inductive-based machines). However, through experimentation and careful observation, it has been noted that for most applications conventional electrostatic machines suffer from a number of drawbacks due to the large drive voltages required to generate the electric fields. As one example, it can be challenging to generate the larger kilovolt-range DC voltage required to generate a DC electrostatic field on the rotor plate electrodes (or stator plate electrodes) for many applications. It is similarly challenging to generate the AC voltage to be applied to the stator plates (or rotor plates) because the frequency of the AC voltage is proportional to rotor frequency and essentially becomes a DC voltage when the rotor is at rest or rotating at very low speeds. For instance, while transformers are a cost-effective solution to step up AC voltages, transformers cannot easily be used to step up low frequency voltages and cannot step up DC voltages. Rather, complex and expensive circuits are typically required to generate large DC voltages. As another example drawback, large DC voltages may induce undesirable electrochemical reactions on the capacitive electrodes of the stator and/or rotor plates, which may cause material decomposition, formation of undesirable materials, or other undesirable results on the plates, electrodes, and/or dielectric fluid. While such electrochemical reactions may be mitigated by forming insulative coatings on the electrodes, it has also been discovered that such coatings can impair the torque-producing electric fields under DC conditions. It has also been discovered that passivated coatings may not always be sufficient for protecting the electrodes or for maintaining the stability of the dielectric fluid.

Therefore, for all the reasons stated above, and all the reasons stated below, there is a need in the art for an improved electrostatic machine system.

Thus, it is an object of the disclosure to provide an electrostatic machine system that improves upon the state of the art.

Another object of the disclosure is to provide an electrostatic machine system having a stator and a rotor both configured to be driven by alternating current.

Yet another object of the disclosure is to provide an electrostatic machine system that avoids the need to generate large DC voltages.

Another object of the disclosure is to provide an electrostatic machine system capable of providing full torque at any operating speed.

Yet another object of the disclosure is to provide an electrostatic machine system that reduces manufacturing costs.

Another object of the disclosure is to provide an electrostatic machine system that inhibits electrochemical damage to capacitive electrodes of the stator and/or the rotor, to the rotor and/or stator plates, or to the dielectric fluid of an electrostatic machine.

Yet another object of the disclosure is to provide a controllable electrostatic machine system by incorporating modern switched mode power supply (SMPS) technology.

These and other objects, features, or advantages of the disclosure will become apparent from the specification, figures and claims.

### SUMMARY OF THE DISCLOSURE

In one or more arrangements, an electrostatic machine is presented that includes a rotor and a stator. The rotor has a first set terminals configured to receive a first multiphase AC drive voltage (V_{R}) and the stator has a second set of terminals configured to receive a second multiphase AC drive voltage (V_{S}). When V_{R} is applied to the first set of terminals and V_{S} is applied to the second set of terminals, the rotor and the stator generate respective electric fields which, when properly aligned, cause the rotor to produce torque relative to the stator and induce rotational motion when sufficient torque is generated.

### BRIEF DESCRIPTION OF THE DRAWINGS

FIG. 1A shows a front view of an example rotor plate for an electrostatic machine, in accordance with one or more arrangements.

FIG. 1B shows a front view of an example stator plate for an electrostatic machine, in accordance with one or more arrangements.

FIG. 1C shows a side view of the example rotor plate of FIG. 1A and the example stator plate of FIG. 1B in a stack arrangement for use in an electrostatic machine, in accordance with one or more arrangements.

FIG. 2A shows an example rotor plate stator plate stack for use in an electrostatic machine, in accordance with one or more arrangements; the view showing the stack having one rotor plate and one stator plate.

FIG. 2B shows an example rotor plate stator plate stack for use in an electrostatic machine, in accordance with one or more arrangements; the view showing the stack having one rotor plate and two stator plates.

FIG. 2C shows an example rotor plate stator plate stack for use in an electrostatic machine, in accordance with one or more arrangements; the view showing the stack having a number (n) of alternative rotor plates and stator plates.

FIG. 3 shows a side view of a set of multiphase capacitive electrodes of a rotor plate and a set of multiphase capacitive electrodes of a stator plate, in accordance with one or more arrangements; the view illustrating application of multiphase AC voltages V_{R} and V_{S} to the multiphase capacitive electrodes of the rotor plate and stator plate respectively.

FIG. 4 shows a side view of a set of multiphase capacitive electrodes of a rotor plate and multiphase capacitive electrodes of a pair of stator plates, in accordance with one or more arrangements; the view illustrating capacitive electrodes formed on both sides of the rotor plate.

FIG. 5 shows a diagram of a multiphase drive system configured to drive a rotor and a stator of a multiphase electrostatic machine with multiphase AC voltages V_{R} and V_{S}, in accordance with one or more arrangements; the view showing the multiphase drive system having a rotor drive circuit configured to generate the multiphase AC voltage V_{R} and a stator drive circuit configured to generate the multiphase AC voltage V_{S}.

FIG. 6 shows a diagram of a multiphase drive system configured to drive a rotor and a stator of a multiphase electrostatic machine with multiphase AC voltages V_{R} and V_{S}, in accordance with one or more arrangements; the view showing the multiphase drive system having a rotor drive circuit configured to generate the multiphase AC voltage V_{R} and a stator drive circuit configured to generate the multiphase AC voltage V_{S}; the view showing the rotor drive circuit and the stator drive circuit having respective variable frequency drives.

FIG. 7 shows a diagram of a multiphase drive system configured to drive a rotor and a stator of a multiphase electrostatic machine with multiphase AC voltages V_{R} and V_{S}, in accordance with one or more arrangements; the view showing the multiphase drive system having a rotor drive circuit configured to generate the multiphase AC voltage V_{R} and a stator drive circuit configured to generate the multiphase AC voltage V_{S}; the view showing the rotor drive circuit and the stator drive circuit having respective variable frequency drives and respective boost circuits.

FIG. 8 shows a circuit diagram of an example multiphase drive system implementation, in accordance with one or more arrangements.

FIG. 9 shows a circuit diagram of an example multiphase drive system implementation, in accordance with one or more arrangements.

FIG. 10 shows a circuit diagram of an example multiphase drive system implementation, in accordance with one or more arrangements.

FIG. 11 shows a diagram of an example control system for use with an electrostatic machine system, in accordance with one or more arrangements.

FIG. 12 shows a flowchart of an example process that may be performed by the control system to control operation of multiphase drive system for an electrostatic machine, in accordance with one or more arrangements.

FIG. 13 shows a circuit diagram of an example multiphase drive system implementation, in accordance with one or more arrangements; the view showing the multiphase drive system providing a single multiphase AC voltage and boost circuit; the view showing the rotor and stator voltages connected to the boost circuit and the rotor and stator voltages connected to each other in anti-parallel; the view further showing the use of a shaft position sensor.

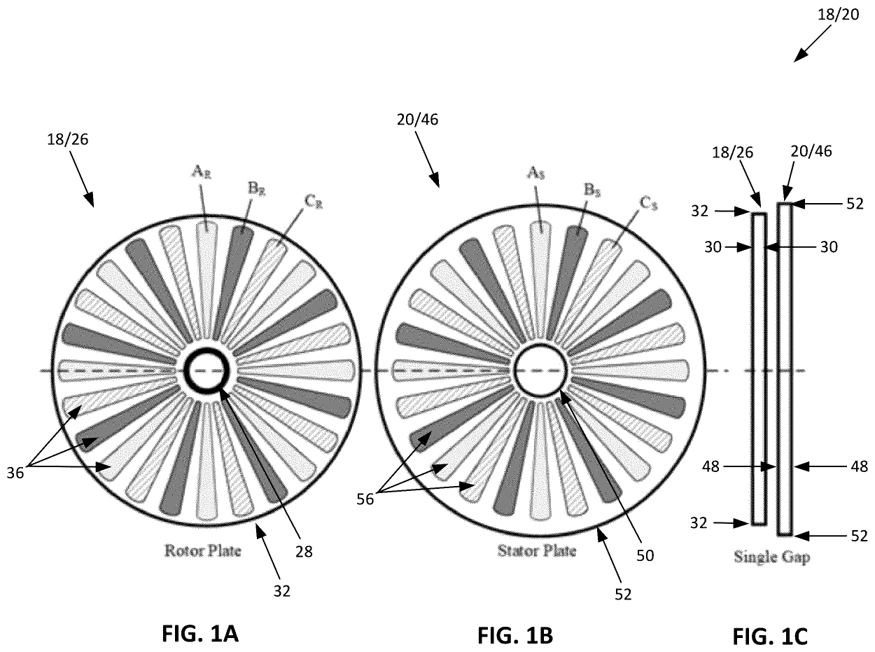

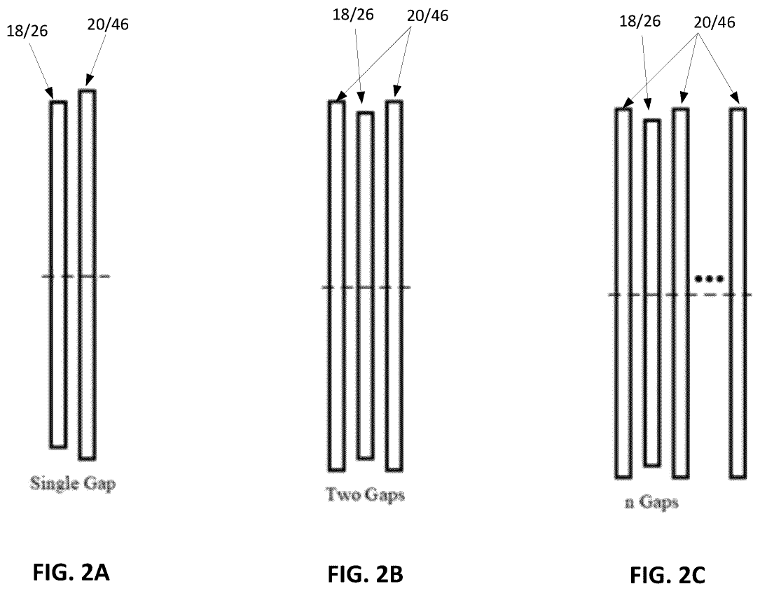

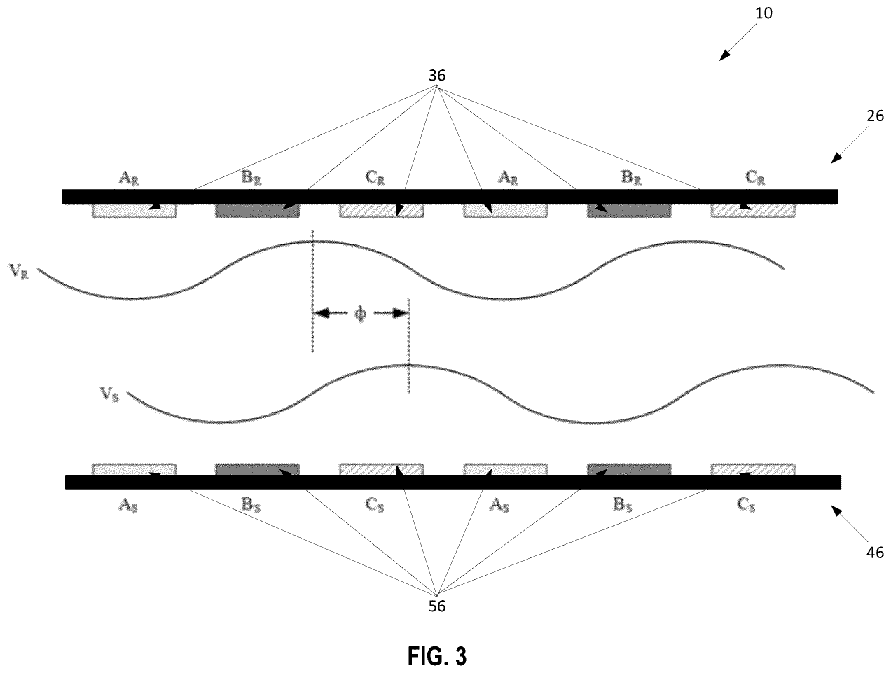

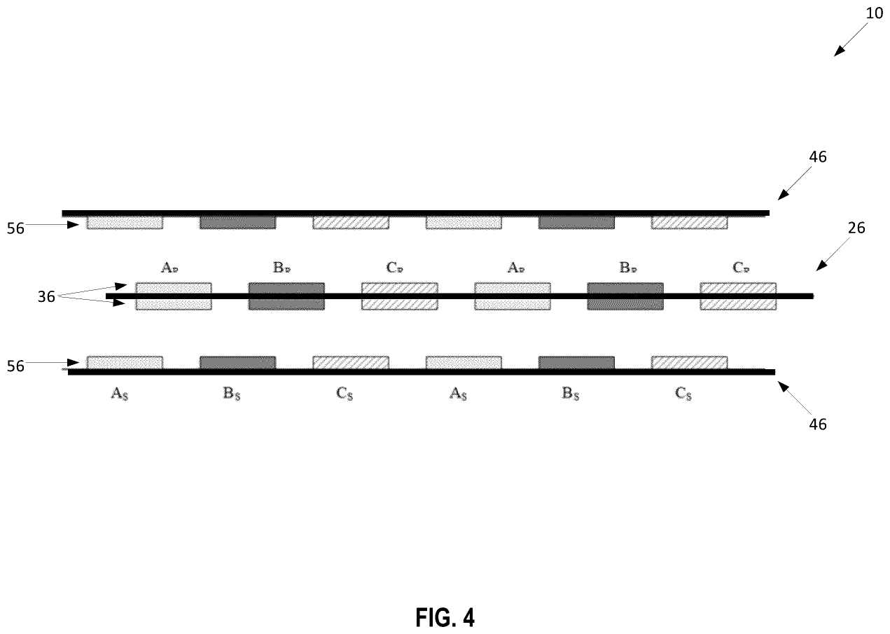

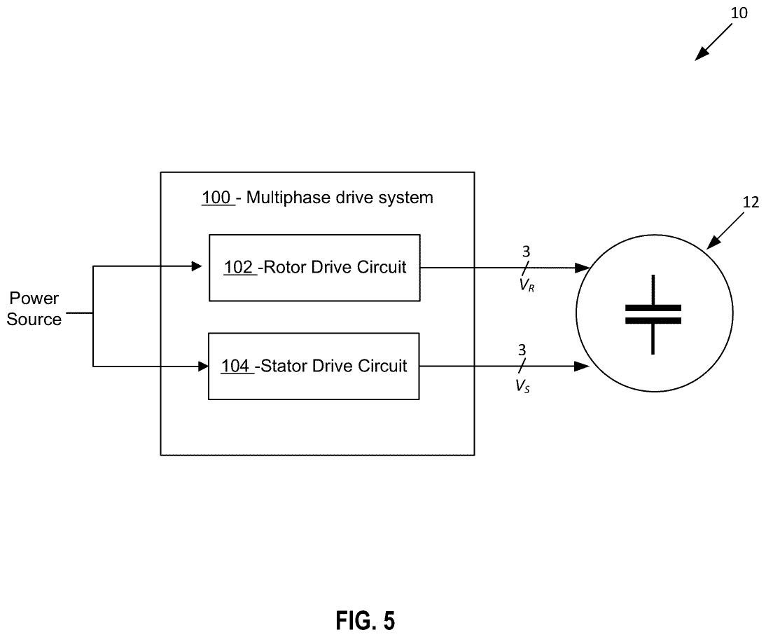

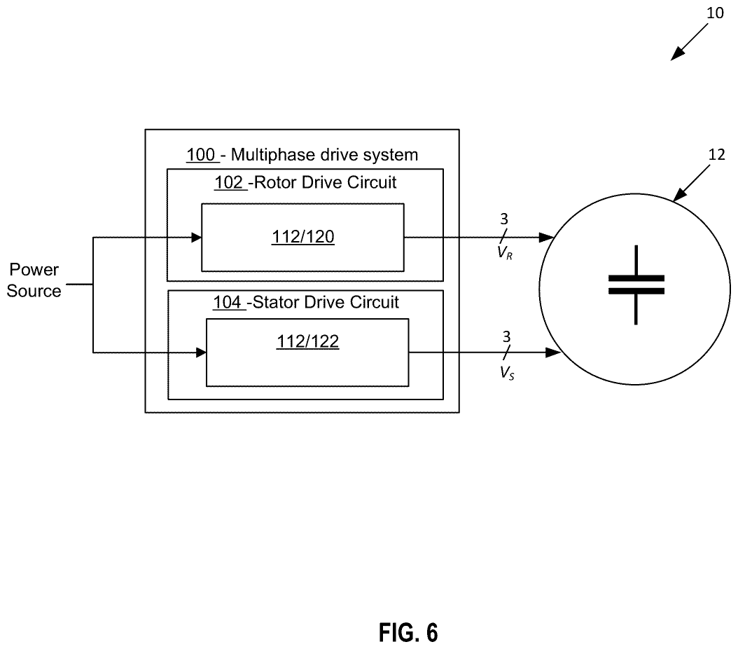

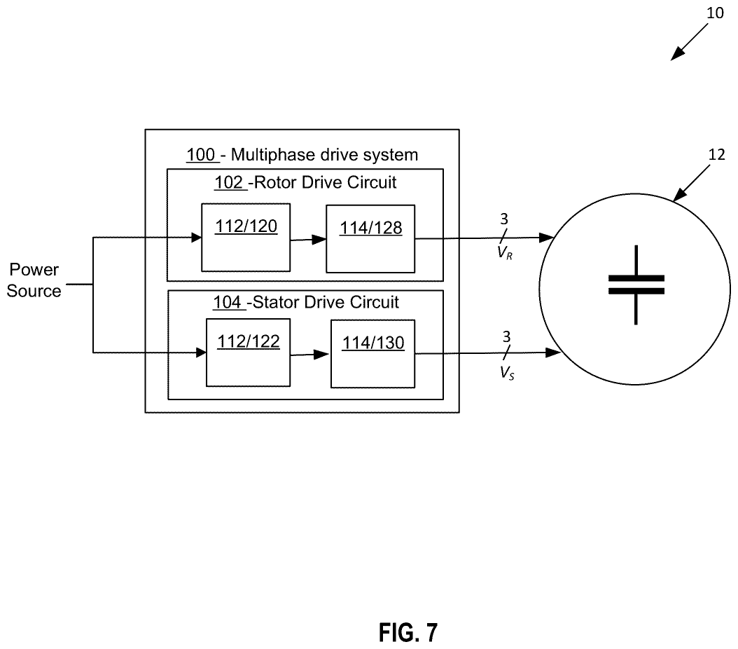

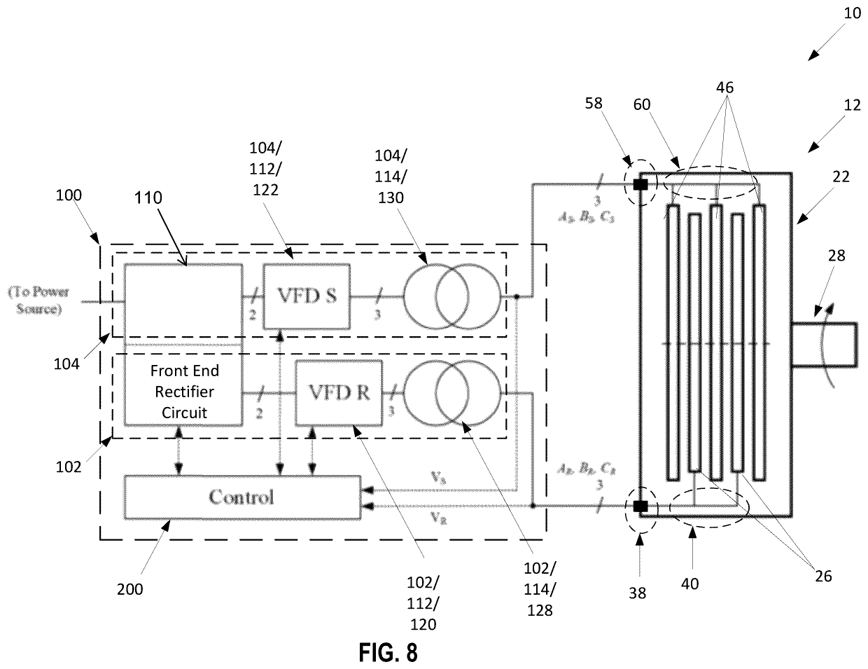

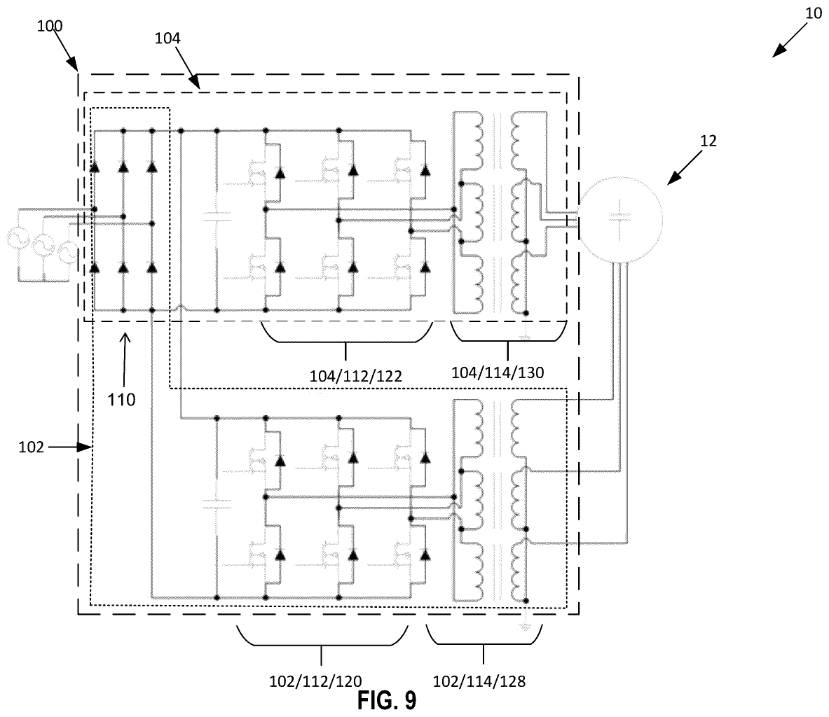

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of window treatments, the embodiments are not so limited. It is appreciated that the embodiments may be adapted for use in other applications which may be improved by the disclosed structures, arrangements and/or methods.

It is to be understood that the terms such as “left,” “right,” “top,” “bottom,” “front,” “back,” “side,” “height,” “length,” “width,” “upper,” “lower,” “interior,” “exterior,” “inner,” “outer,” and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of rotating electrostatic machines. However, the embodiments are not so limited. It is appreciated that the embodiments may be adapted for use in other applications which may be improved by the disclosed structures, arrangements and/or methods. The system is merely shown and described as being used in the context of rotating electrostatic machines for ease of description and as one of countless example applications.

Turning now to the figures, an AC driven electrostatic machine system is presented, as is shown as one example.

### System 10:

With reference to the figures, an AC driven electrostatic machine system 10 (or simply system 10) is presented. In an arrangement shown, as one example, system 10 includes an electrostatic machine 12, having a multiphase rotor 18 and a multiphase stator 20, and a multiphase drive system 100 for operation thereof, among other components.

### Electrostatic Machine 12:

Electrostatic Machine 12 is formed of any suitable size, shape, design, and technology, and is configured to convert electric energy to rotational motion by interaction between electric fields generated by AC driven capacitive electrodes. In an arrangement shown, as one example, electrostatic machine 12, includes a multiphase rotor 18 and a multiphase stator 20 positioned within a housing 22, among other components.

### Multiphase Rotor 18:

Multiphase rotor 18 is formed of any suitable size, shape, design, and technology, and is configured to rotate within housing 22 and facilitate generation of electric fields to interact with electric fields of multiphase stator 20 to create torque and thereby induce rotational motion when sufficient torque is generated. In the arrangement shown, as one example, multiphase rotor 18 includes one or more rotor plates 26 operatively connected with and configured to rotate about shaft 28. In this example arrangement, rotor plates 26 have generally planar shaped surfaces 30 extending outward from shaft 28 at their origin to a circular outer edge 32. In one or more arrangements, rotor plates 26 have capacitive electrodes 36 positioned on and/or in one or both surfaces 30. In the arrangement shown, as one example, capacitive electrodes 36 are positioned in a symmetric circular arrangement configured to align with capacitive electrodes 56 of stator plates 46 as rotor plates 26 rotate.

In one or more arrangements, multiphase rotor 18 includes a set of multiphase terminals 38. Multiphase terminals 38 are formed of any suitable size, shape, design, and technology, and are configured to facilitate providing a multiphase AC voltage (V_{R}) to the capacitive electrodes 36 of the rotor plates 26. More specifically, in the arrangement shown, multiphase terminals 38 are electrically connected to capacitive electrodes 36 by a wiring network 40 (e.g., wires, traces, brushes, connector, and/or other electric conductive paths) configured to provide each phase of V_{R} to a respective subset of capacitive electrodes 36.

In one or more arrangements, as is shown, multiphase terminals 38 of multiphase rotor 18 are configured to be driven by a three-phase AC voltage. In this example arrangement, the subsets of the capacitive electrodes 36 for the three phases of V_{R} are positioned in a circular series extending along the outer edge 32 of rotor plates 26. In this example arrangement, subsets of the capacitive electrodes 36 are positioned in alternating order (e.g., phase A_{R}, phase B_{R}, phase C_{R}, phase A_{R}, phase B_{R}, phase C_{R} . . . ).

### Multiphase Stator 20:

Multiphase stator 20 is formed of any suitable size, shape, design, and technology, and is configured to be fixed in position within housing 22 and facilitate generation of electric fields to interact with electric fields of multiphase rotor 18 and create torque and thereby induce rotational motion of the multiphase rotor 18 when sufficient torque is generated. In the arrangement shown, as one example, multiphase stator 20 includes one or more stator plates 46 operatively connected with housing 22 in a fixed stationary position.

Similar to rotor plates 26, in the example arrangement shown, stator plates 46 have generally planar shaped surfaces 48 extending outward from a central hub 50 (e.g., positioned around shaft 28) to a circular outer edge 52. In one or more arrangements, stator plates 46 have capacitive electrodes 56 positioned on and/or in one or both surfaces 48. In the arrangement shown, as one example, capacitive electrodes 56 of stator plates 46 are positioned in a symmetric circular arrangement configured to align with capacitive electrodes 36 of neighboring rotor plates 26 as stator plates 46 rotate.

In one or more arrangements, multiphase stator 20 includes a set of multiphase terminals 58. Multiphase terminals 58 are formed of any suitable size, shape, design, and technology, and are configured to facilitate providing a multiphase AC voltage (V_{S}) to the capacitive electrodes 56 of the stator plates 46. More specifically, in the arrangement shown, multiphase terminals 58 are electrically connected to capacitive electrodes 56 by a wiring network 60 (e.g., wires, traces, brushes, connector, and/or other electric conductive paths) configured to provide each phase of V_{S} to a respective subset of capacitive electrodes 56.

In the example arrangement shown, similar to multiphase terminals 38 of multiphase rotor 18, multiphase terminals 58 of multiphase stator 20 are each configured to be driven by a three-phase AC voltage V_{S}. In this example arrangement, the subsets of the capacitive electrodes 56 are positioned in a circular series extending along the outer edge 52 of stator plates 46. In this example arrangement, the subsets of the capacitive electrodes 56 are positioned in an alternating order (e.g., phase A_{S}, phase B_{S}, phase C_{S}, phase A_{S}, phase B_{S}, phase C_{S} . . . ), mirroring the arrangement of capacitive electrodes 36 of rotor plates 26.

Although, some various arrangements may be primarily described with reference to multiphase rotor 18 and multiphase stator 20 being configured to be driven by three phase AC voltages (e.g., V_{R} and V_{S}), the arrangements are not so limited. Rather, it is contemplated that in some various arrangements, multiphase rotor 18 and multiphase stator 20 may be configured to be driven by V_{R} and V_{S} voltages having any number of phases and/or using various additional or alternative arrangements/positioning of capacitive electrodes 36 and capacitive electrodes 56. Moreover, while some arrangements may be primarily described and/or illustrated with reference to sinusoidal waveforms, the arrangements are not so limited. Rather, it is contemplated that in some various arrangements, multiphase rotor 18 and multiphase stator 20 may be configured to be driven by any type of waveform including but not limited to, for example sinusoidal waveforms, square waveforms, rectangular waveforms, triangular waveforms, sawtooth waveforms, and/or any other shaped waveforms.

For ease of explanation, multiphase rotor 18 and multiphase stator 20 may be primarily described with reference to each having a single rotor plate 26 or stator plate 46. However, the arrangements are not so limited. Rather, it is contemplated that in some various arrangements, multiphase rotor 18 and/or multiphase stator 20 may include multiple rotor plates 26 and/or stator plates 46. As one illustrative example, in one or more arrangements, electrostatic machine 12 may include a stack of alternating rotor plates 26 and stator plates 46 extending along shaft 28 (e.g., rotor plate 26, stator plate 46, rotor plate 26, stator plate 46, rotor plate 26, stator plate 46 . . . ). However, the arrangements are not so limited. Rather, it is contemplated that in some various arrangements, electrostatic machine 12 may include rotor plates 26 and stator plates 46 in various different arrangements.

### Housing 22:

Housing 22 is formed of any suitable, size, shape, design, and technology and is configured to enclose and house multiphase stator 20 and multiphase rotor 18 in positions sufficient to facilitate electrostatic induced rotation of multiphase rotor 18 during operation. In one or more arrangements, housing 22 includes openings or electric pathways to facilitate provision of drive voltages V_{R} and V_{S} (e.g., generate by drive system 100) to the sets of multiphase terminals 38 and multiphase terminals 58. In some arrangements, multiphase terminals 38 and multiphase terminals 58 may be positioned on and/or formed in housing 22 so they are accessible from an exterior of housing. In some arrangements, housing 22 may provide a sealed enclosure for housing multiphase rotor 18 and multiphase stator 20 (although arrangements with an open enclosure are also contemplated). In one or more arrangements, housing 22 may be configured to be filled with dielectric fluid, for example, to provide insulation between rotor plates 26 and stator plates 46, enhance torque production using non-unity dielectric permittivity, provide lubrication to facilitate smooth movement of multiphase rotor 18, and/or circulate the dielectric fluid for cooling purposes. Moreover, it is contemplated that in some arrangements, multiphase drive system 100, control system 200, and/or other components of system 10 may also be incorporated into housing 22.

### In Operation:

In operation of electrostatic machine 12, multiphase rotor 18 and multiphase stator 20 are driven by complementary AC voltages that are configured to generate complementary electric fields at capacitive electrodes 36 and capacitive electrodes 56 to induce sheer forces between rotor plate 26 and stator plate 46 and thereby cause rotor plates 26 and shaft 28 of multiphase rotor 18 to rotate relative to the stationary multiphase stator 20. In one or more arrangements, V_{R} and V_{S} are generated and/or applied to capacitive electrodes 36 and capacitive electrodes 56 so that the electric field generated by capacitive electrodes 36 of rotor plates 26 has a phase offset @ relative to the electric field generated by opposing capacitive electrodes 56 of stator plates 46. Due to the phase offset @, sheer force is generated between rotor plates 26 and stator plates 46, thereby producing torque and, with sufficiently high torque, causing multiphase rotor 18 to rotate.

In one or more arrangements, the frequency of V_{R} and/or V_{S} may be adjusted in response to an increase and/or decrease of rotational speed of multiphase rotor 18 during operation. For example, in one or more arrangements, V_{R} and/or V_{S} may be adjusted during operation as required according to the function:

$${Ω}_{S} = {Ω}_{R} + {Ω}_{M} , \qquad ( 1 )$$

where Ω_{S} is the frequency of the V_{S} voltage provided to the multiphase terminals 58 of the multiphase stator 20, Ω_{R} is the frequency of the V_{R} voltage provided to the multiphase terminals 38 of the multiphase rotor 18, and Ω_{M} is the frequency of mechanical rotation of the rotor plates 26. It is understood that relation of the above equation (1) holds whether the frequencies utilize electrical or mechanical quantities. In one or more arrangements, the frequency of V_{R} and/or V_{S} may also be adjusted simultaneously as required to maintain a constant rotational speed of the rotor according to equation (1).

In some arrangements, V_{S} may be generated with a constant frequency Ω_{S}, while the frequency Ω_{R} of V_{R} is varied as a function of Ω_{M} to adjust operating speed. Conversely, in some arrangements, V_{R} may be generated with a constant frequency Ω_{R}, while the frequency Ω_{S} of V_{S} is varied as a function of Ω_{M} to adjust operating speed. In yet some other arrangements, the frequency Ω_{S} of V_{S} and the frequency Ω_{R} of V_{R} may both be adjusted as a function of Ω_{M} to adjust operating speed.

These approaches may permit V_{S} and V_{R} to be configured in a manner such that both V_{S} and V_{R} are AC voltages throughout the entire operating speed range of the electrostatic machine 12 (e.g., from zero speed to top speed). For example, from the above equation (1) at zero speed (i.e., Ω_{M}=0), the frequency Ω_{S} of V_{S} is equal to the frequency Ω_{R} of V_{R}, and full torque may be generated by the electrostatic machine 12 using AC voltages for V_{R} and V_{S}. AC V_{S} and V_{R} voltages may similarly be configured to operate the electrostatic machines 12 through entire negative operating speed range of the electrostatic machine 12 (e.g., from zero speed to top speed in the reverse direction.) As a result, generated V_{R} and V_{S} voltages can easily be boosted to larger voltages, as may be required for any particular application, using transformer circuits, which are generally simple, inexpensive, and reliable.

As another possible benefit, if multiphase rotor 18 and multiphase stator 20 are only driven by AC voltages, material decomposition, formation of undesirable materials, or other undesirable reactions of capacitive electrodes 36/56 that are typically caused by DC operation can be mitigated and/or eliminated entirely.

In one or more arrangements, torque generated at any particular operating speed of the electrostatic machine 12 may be adjusted by adjusting the magnitude of the AC voltages for V_{R} and V_{S}. The theoretical maximum torque Tₑ that may be optimally generated is given by the following:

$${T}_{e} = \pm \frac{3 P}{2} {C}_{m} {V}_{S} {V}_{R} , \qquad ( 2 )$$

where P is the pole number (e.g., number of capacitive electrodes 36/56 extending along the outer edge 32/52 of rotor plates 26/stator plates 46 divided by the number of phases) and Cₘ is the mutual capacitance of the stator and rotator electric fields.

### Outrunner Configuration:

While some arrangements may be primarily described with reference to electrostatic machines 12 having a multiphase rotor 18 configured to rotate relative to a stationary housing 22 and multiphase stator 20, the arrangements are not so limited. Rather, it is contemplated that in some various arrangements, electrostatic machines 12 may be adapted for use in what is referred to as an “outrunner” configuration, where multiphase rotor 18 is held stationery and housing 22 and multiphase stator 20 rotate about multiphase rotor 18. Moreover, the principal of operation of disclosed electrostatic machines 12 arrangements is similarly thought to be applicable to any other electrostatic machine arrangement.

### Multiphase Drive System 100:

Multiphase drive system 100 is formed of any suitable size, shape, design, and technology, and is configured to generate multiphase AC drive voltages (e.g., V_{R} and V_{S}) to operate electrostatic machine 12 (or similarly operated electrostatic machine). In one or more example arrangements, as is shown, multiphase drive system 100 includes a rotor drive circuit 102, a stator drive circuit 104, and a control system 200, among other components.

### Rotor Drive Circuit 102 and Stator Drive Circuit 104:

Rotor drive circuit 102 and stator drive circuit 104 are formed of any suitable, size, shape, design, and technology, and are configured to respectively generate a first multiphase AC voltage (e.g., V_{R}) to drive multiphase rotor 18 and generate a second multiphase AC voltage (e.g., V_{S}) to drive multiphase stator 20 in a manner such that desired rotation of drive multiphase rotor 18 is induced. Rotor drive circuit 102 and stator drive circuit 104 may each be implemented using various methods and/or means to generate and/or boost suitable multiphase voltages for operation of electrostatic machine 12 and are not limited to the example arrangements disclosed herein.

In one or more arrangements, rotor drive circuit 102 and stator drive circuit 104 each include a respective waveform generation stage 112 to generate AC voltages (e.g., for generation of V_{R} and V_{S}). The respective waveform generation stage 112 of rotor drive circuit 102 and stator drive circuit 104 are formed of any suitable, size, shape, design, and technology, and are configured to generate AC voltages at the frequencies required for desired operation of electrostatic machine 12 (or similar electrostatic machine). In one or more arrangements, as one example, the waveform generation stages 112 of rotor drive circuit 102 and stator drive circuit 104 are implemented using respective variable frequency drives (e.g., rotor variable frequency drive 120 and stator variable frequency drive 122). However, the arrangements are not so limited. Rather, it is contemplated that waveform generation stages 112 of rotor drive circuit 102 and stator drive circuit 104 may be implemented using various additional and/or alternative AC signal generation circuits including but not limited to, for example, variable frequency drives, voltage source inverters, current source inverters, Z-source inverter, other power converter, and/or any other method or means for generating suitable AC voltages.

Moreover, in some arrangements, rotor drive circuit 102 and stator drive circuit 104 may be formed using different circuit designs. For instance, as previously described, in some arrangements, either multiphase rotor 18 or multiphase stator 20 may be driven at a constant frequency, while frequency of the other is adjusted to adjust speed. In such arrangements, only one of rotor drive circuit 102 and stator drive circuit 104 would require a variable frequency drive for frequency adjustment. The other drive circuit may be configured to provide a fixed frequency AC signal that is non-adjustable. As an illustrative example, in some implementations, such a fixed frequency AC signal may be provided by a fixed high voltage AC source (e.g., wall power) boosted with a transformer.

In one or more arrangements, rotor drive circuit 102 and stator drive circuit 104 may include respective boost stage circuits 114. The boost stage circuits 114 are formed of any suitable, size, shape, design, and technology, and are configured to boost the amplitude of the AC voltages (e.g., V_{R} and V_{S}) generated by rotor variable frequency drive 120 and stator variable frequency drive 122 (or by other waveform generation stage circuits 112) as required to cause electrostatic machine 12 to generate desired torque for operation. In one or more example arrangements shown, the boost stages 114 of rotor drive circuit 102 and stator drive circuit 104 are implemented using transformer-based circuits (e.g., rotor transformer boost circuit 128 and stator transformer boost circuit 130). In one or more arrangements, rotor transformer boost circuit 128 and stator transformer boost circuit 130 are configured to boost the amplitude of AC voltages generated by the waveform generation stage circuits 112 before providing the AC voltages to multiphase terminals 38 of multiphase rotor 18 and/or multiphase terminals 58 of multiphase stator 20. In one or more arrangements, use of transformers for the boost circuit beneficially provides isolation between the motor and the drive, which helps reduce unwanted behaviors such as common mode voltages, common mode currents, and ground currents. In one or more arrangements, rotor transformer boost circuit 128 and stator transformer boost circuit 130 are multiphase transformers configured to generate the multiple phase components from the AC voltages generated by the waveform generation stage circuits 112. It is recognized that transformers, like all electrical components, contain some amount of undesirable characteristics, sometimes referred to as ‘parasitic components’ or ‘parasitics,’ including inductances, capacitances, and losses. These parasitics can impair the operation of the invention if sufficiently large, e.g. creating resonances which limit useful frequencies. Therefore, it is understood that the transformers may further comprise zero, one, or multiple filter circuits to modify the frequency response of the system through attenuation, damping and/or clamping of signals within certain ranges of frequencies and voltages. Such filter circuits may be active or passive, comprising inductors, capacitors, resistors, ferrite beads, diodes, transistors, transorbs, gas discharge tubes, varistors, and related components into networks including but not limited to low pass, high pass, bandpass, bandstop, band-reject, and/or notch filters, with or without clamping. In some arrangements, the transformer parasitics may comprise part of the filter.

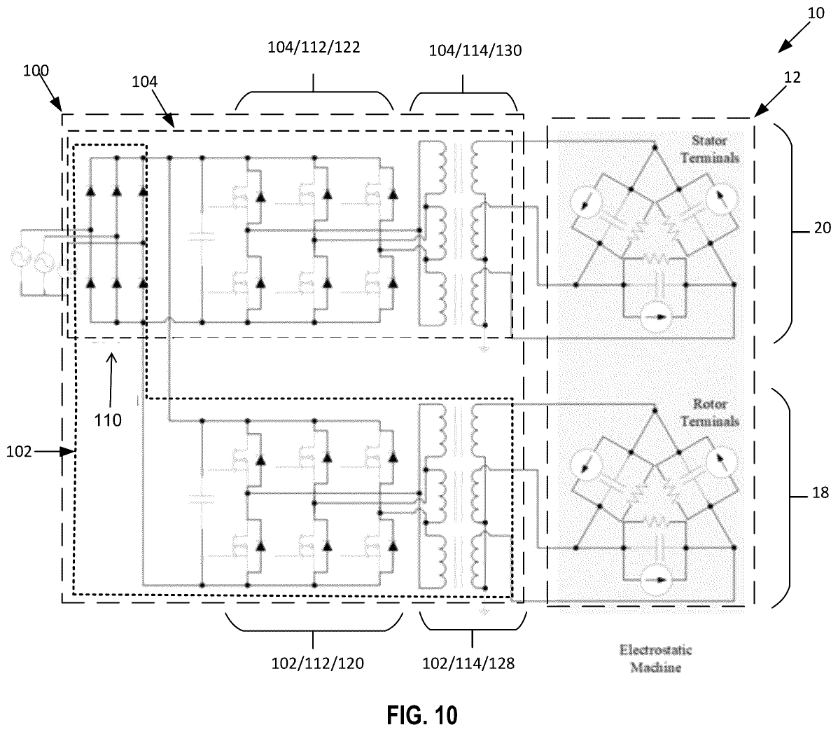

However, the arrangements are not so limited. Rather, it is contemplated that in some arrangements, rotor drive circuit 102 and stator drive circuit 104 may be implemented using various additional or alternative stages and/or circuits. Moreover, in some arrangements, rotor drive circuit 102 and stator drive circuit 104 may be implemented together and/or may share circuits in certain stages. (e.g., to perform a common function). For example in some arrangements, rotor drive circuit 102 and stator drive circuit 104 may share a front end rectifier stage 110, for example, as shown in FIG. 10.

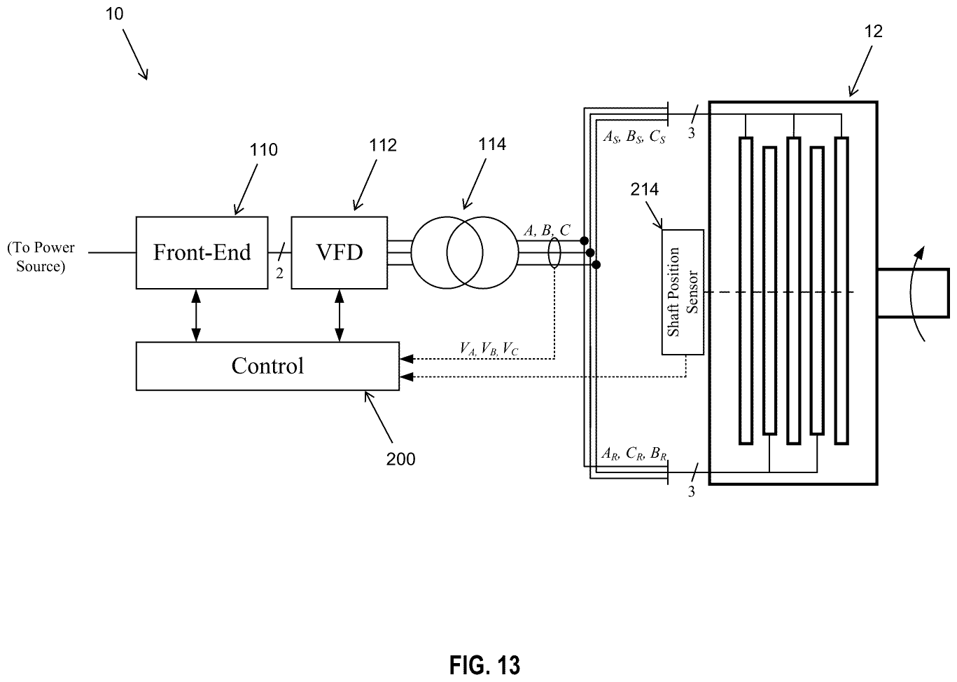

As another example, in some arrangements, a combined variable frequency drive circuit may be used in both rotor drive circuit 102 and stator drive circuit 104. One such arrangement may utilize one 3-phase variable frequency drive for rotor drive circuit 102, and a second 3-phase variable frequency drive for stator drive circuit 104. A second such arrangement may utilize one 3-phase variable frequency drive to both rotor drive circuit 102 and stator drive circuit 104, with the wire phase sequencing of the two drive circuits reversed, also referred to herein as ‘anti-parallel’ configuration (e.g., for stator phases ABC and rotor phases XYZ, connections A-X, B-Z and C-Y are made, where ‘-’ denotes an electrical connection, and sequencing of ABC and XYZ phases are denoted in the same rotational direction). FIG. 13 shows such an example anti-parallel configuration, in accordance with one or more arrangements. For additional information on some additional and/or alternative circuits that may be adapted for use in some implementations of rotor drive circuit 102 and/or stator drive circuit 104, reference may be made to U.S. Provisional Patent Application 63/491,953 titled VARIABLE FREQUENCY DRIVE FOR ELECTROSTATIC MACHINES and filed Mar. 23, 2023, which is hereby incorporated by reference herein.

It is recognized by those skilled in the art that transformers may be combined to produce equivalent transformers with greater numbers of phases. In one example, three single-phase transformers may be combined with primary and secondary windings connected in a “wye” arrangement, a “delta” arrangement, a “zig-zag” arrangement, other arrangements, or any combination thereof, to produce one 3-phase transformer. Similar combinations and arrangements may produce transformers with a wide range of phase counts, and all such combinations and arrangements are understood to be included as a single multiphase transformer.

### Control System 200:

In some arrangements, multiphase drive system 100 includes a control system 200. Control system 200 is formed of any suitable, size, shape, design, and technology, and is configured to control and/or perform operations for one or more components of multiphase drive system 100 and/or other components of system 10. For example, in some arrangements control system 200 is configured to control various components of multiphase drive system 100 to facilitate operation of such components and/or to control adjustment of frequency, amplitude, or other characteristic of the multiphase AC voltages generated by multiphase drive system 100 (e.g., V_{R} and V_{S}).

In some arrangements, control system 200 is configured to monitor operation and/or status of electrostatic machine 12 (e.g., position of rotor plates 26, rotational frequency Ω_{M} of rotor plates 26, and/or any other operational characteristic) and adjust operation of stator drive circuit 104, rotor drive circuit 102, or other system or component of multiphase drive system 100 to cause appropriate multiphase AC voltages to be generated (e.g., as described herein) and provided to electrostatic machine to achieve the desired operation. In one or more arrangements, control system 200 may utilize one or more sensor devices 214 to monitor operation and/or status of electrostatic machine 12 and communicate operational status to control system 200. In some various different arrangements, sensor devices 214 may utilize various methods and/or means to monitor operation and/or status including but not limited to: position sensors, speed sensors, acceleration sensors, optical sensors, voltage sensors, current sensors, electric potential sensors, temperature sensors, and/or any other method or means for monitoring operation and/or status of electrostatic machine 12.

In some arrangements, control system 200 may be configured to adjust operation of stator drive circuit 104, rotor drive 102, or other system or component of multiphase drive system 100, and thus cause appropriate multiphase AC voltages to be generated (e.g., as described herein), by making calculations based on one or multiple position references. These references may include the rotor mechanical positional angle, the rotor field electrical angle, the stator field electrical angle, a calculated combination thereof, a calculation further including measurements from various sensor devices 214 (e.g., as described herein), and/or an arbitrary or fictitious reference, (e.g., generated by control system 200).

In some arrangements, a sensor device 214 may be configured to inject a target signal on one or more capacitive electrodes of one of the rotor plates 26 and/or stator plates 46. The sensor device 214 may be configured to detect the target signal on capacitive electrodes of a neighboring stator plate 46 and/or rotor plate 26 to determine the position of the stator plates 46. For additional information on some example implementations of this method of sensing relative position of rotor plates 26/stator plates 46, reference may be made to U.S. Pat. No. 11,012,003, titled SENSORLESS CONTROLLER FOR ELECTROSTATIC MACHINE and issued May 18, 2021, which is hereby incorporated by reference in its entirety.

### Example Control System 200:

In various different arrangements, control system 200 (and various other functional blocks, modules, controllers, devices, and/or circuits of system 10) may be implemented using various different types of electrical circuits that are specifically configured to carry out one or more of these or related operations/activities. For example, such electronic circuits may include discrete logic circuits or programmable logic circuits configured for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources).

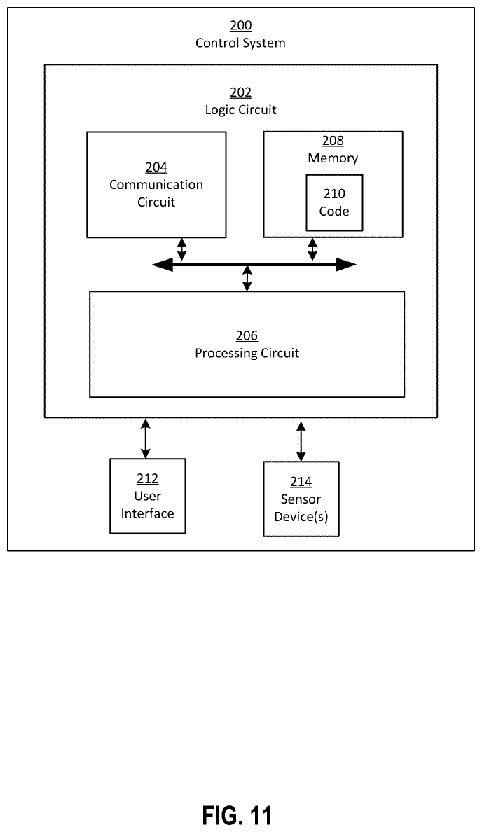

FIG. 11 shows a block level diagram of an example implementation of control system 200, consistent with one or more arrangements. In this example, control system 200 is implemented by a logic circuit 202 having a communication circuit 204, a processing circuit 206, and a memory 208 having software code 210 or instructions that facilitates the operation of system 10, among other components.

Processing circuit 206 may be any computing device that receives and processes information and outputs commands according to software code 210 stored in memory 208. For example, in some various arrangements, processing circuit 206 may be discrete logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 208. Memory 208 may be any form of information storage such as flash memory, RAM memory, DRAM memory, a hard drive, or any other form of memory.

Processing circuit 206 and memory 208 may be formed of a single combined unit. Alternatively, processing circuit 206 and memory 208 may be formed of separate but electrically connected components. Alternatively, processing circuit 206 and memory 208 may each be formed of multiple separate but communicatively connected components.

Software code 210 is any form of instructions or rules that direct processing circuit 206 how to receive, interpret and respond to information to operate as described herein. Software code 210 or instructions are stored in memory 208 and accessible to processing circuit 206. As an illustrative example, in one or more arrangements, software code 210 or instructions may configure processing circuit 206 to monitor user interface 212 and/or various sensor devices 214 of system 10 and perform various preprogramed actions in response to signals from user interface 212 and/or such sensor devices 214 satisfying one or more trigger conditions.

As some illustrative examples, some actions that may be initiated by control system 200 in response to signals from sensor devices 214 and/or user input from user interface 212 include but are not limited to, for example, controlling rotor drive circuit 102 and/or stator drive circuit 104 to adjust frequency of V_{R} and V_{S} during operation of electrostatic machine 12.

Communication circuit 204 is formed of any suitable size, shape, design, technology, and in any arrangement and is configured to facilitate communication with devices to be controlled, monitored, and/or alerted by control system 200. In one or more arrangements, as one example, communication circuit 204 includes a transmitter (for one-way communication) or transceiver (for two-way communication). In various arrangements, communication circuit 204 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, MODBUS RTU, ARM Advanced Microcontroller Bus Architecture (AMBA), USB, Firewire, RFID, MODBUS TCP, EtherNet/IP, Near Field Communication (NFC), infrared and optical communication, 802.3/Ethernet, 802.11/WIFI, Profibus, Wi-Max, Bluetooth, Bluetooth low energy, EtherCAT, Controller Area Network (CAN), Ultra Wideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### User Interface 212:

User interface 212 is formed of any suitable size, shape, design, technology, and in any arrangement and is configured to facilitate user control and/or adjustment of various components of system 10. In one or more arrangements, as one example, user interface 212 includes a set of inputs (not shown). Inputs are formed of any suitable size, shape, design, and technology and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, microphone, or any other form of user input. Optionally, in one or more arrangements, user interface 212 includes a display (not shown). Display is formed of any suitable size, shape, design, technology, and in any arrangement and is configured to facilitate display information of settings, sensor readings, time elapsed, and/or other information pertaining to operation or system 10.

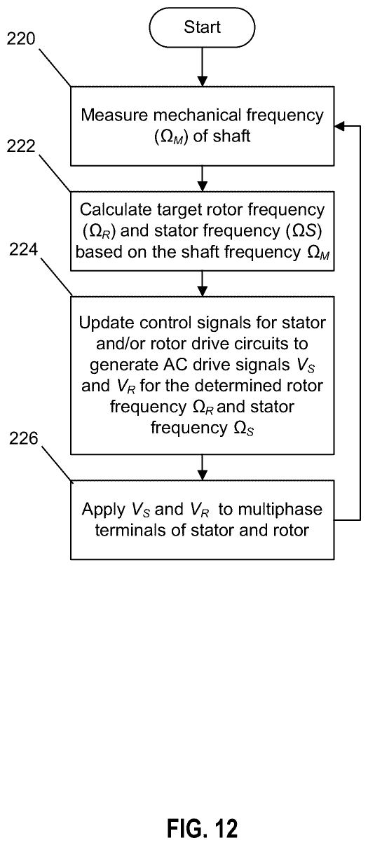

FIG. 12 shows a flowchart of an example process that may be performed by the control system 200 to control operation of multiphase drive system for an electrostatic machine, in accordance with one or more arrangements. In this example arrangement, mechanical frequency Ω_{M} is measured at process block 220. At process block 222, a target rotor frequency Ω_{R} and stator frequency Ω_{S} are calculated based on the measured shaft frequency Ω_{M}. At process block 224, control signals for stator and/or rotor drive circuits 102/104 are updated to generate AC drive signals V_{S} and V_{R} for the determined rotor frequency Ω_{R} and stator frequency Ω_{S}. At process block 226, V_{S} and V_{R} are applied to multi-phase terminals 38/58 of rotor 18 and stator 20. Following process block 226, the process loops back to process block 220 and the process is repeated.

These and other objects, features, or advantages of the disclosure will become apparent from the specification, figures and claims. It will be appreciated by those skilled in the art that other various modifications could be made to the device without parting from the spirit and scope of this disclosure. All such modifications and changes fall within the scope of the claims and are intended to be covered thereby.

### SELECT REFERENCE NUMBERS

10-System
12-Electrostatic Machine
18-Multiphase Rotor (of Electrostatic Machine 12)
20-Multiphase Stator (of Electrostatic Machine 12)
22-Housing (of Electrostatic Machine 12)
26-Rotor Plates (of Multiphase Rotor 18)
28-Shaft (of Multiphase Rotor 18)
30-Surfaces (of Rotor plates 26)
32-Outer Edge (of Rotor plates 26)
36-Capacitive Electrodes (of Rotor plates 26)
38-Multiphase Terminals (of Multiphase Rotor 18)
40-Wiring Network (of Multiphase Rotor 18)
46-Stator Plates (of Multiphase Stator 20)
48-Surfaces (of Stator Plates 46)
50-Hub (of Stator Plates 46)
52-Outer Edge (of Stator Plates 46)
56-Capacitive Electrodes (of Multiphase Stator 20)
58-Multiphase Terminals (of Multiphase Stator 20)
60-Wiring Network (of Multiphase Stator 20)
100-Multiphase Drive System
102-Rotor Drive Circuit (of Multiphase Drive System 100)
104-Stator Drive Circuit (of Multiphase Drive System 100)
110-Front End Rectifier Stage
112-Waveform generation stage
114-Boost Stage
120-Rotor Variable Frequency Drive
122-Stator Variable Frequency Drive
128-Rotor Transformer Boost Circuit
130-Stator Transformer Boost Circuit
200-Control System
202-Logic Circuit (of Control System 200)
204-Communication Circuit (of Control System 200)
206-Processing Circuit (of Control System 200)
208-Memory (of Control System 200)
210-Code (of Control System 200)
212-User Interface (of Control System 200)
214-Sensor Device(s) (of Control System 200)
220-Process Block
222-Process Block
224-Process Block
226-Process Block

What is claimed is:

1. An electrostatic machine system, comprising:
a rotor;
a stator;
wherein the rotor has a first set of terminals configured to receive a first multiphase AC drive voltage (V_{R});
wherein the stator has a second set of terminals configured to receive a second multiphase AC drive voltage (V_{S});
wherein when V_{R} is applied to the first set of terminals and V_{S} is applied to the second set of terminals,
the rotor and the stator generate respective electric fields which cause the production of torque between the rotor and stator.

2. The system of claim 1, wherein during operation V_{S} has a frequency equal to the sum of a frequency of V_{R} and a frequency of mechanical rotation of the rotor.

3. The system of claim 1, further comprising a multiphase drive system configured to generate V_{R} and V_{S}.

4. The system of claim 1, further comprising a multiphase drive system;
the multiphase drive system including a first drive circuit configured to generate V_{R} and a second drive circuit configured to generate V_{S}.

5. The system of claim 1, further comprising a multiphase drive system;
the multiphase drive system including a first drive circuit configured to generate V_{R} and a second drive circuit configured to generate V_{S};
wherein the first drive circuit and the second drive circuit are variable frequency drives, voltage source inverters, current source inverters, or Z-source inverters.

6. The system of claim 1, further comprising a multiphase drive system;
wherein the multiphase drive system includes a variable frequency drive configured to generate a first AC voltage and a second variable frequency drive configured to generate a second AC voltage.

7. The system of claim 1, further comprising a multiphase drive system;
wherein the multiphase drive system includes a variable frequency drive configured to generate a first AC voltage;
wherein the multiphase drive system includes a second variable frequency drive configured to generate a second AC voltage;
wherein the multiphase drive system includes a first transformer circuit configured to boost the first AC voltage;
wherein the multiphase drive system includes a second transformer circuit configured to boost the second AC voltage.

8. The system of claim 1, further comprising:
a multiphase drive system configured to generate a first AC signal and a second AC signal;
one or more multiphase transformers configured to generate the multiple phases of V_{R} from the first AC signal and generate the multiple phases of V_{S} from the second AC signal.

9. The system of claim 1, wherein V_{R} is applied to the rotor in a first direction and V_{S} is applied to the stator in a second direction that is opposite the first direction so as to cause the production of torque between the rotor and stator.

10. The system of claim 2, further comprising a multiphase drive system including a drive circuit configured to generate a multiphase AC drive voltage that is provided to the first set of terminals of the rotor as V_{R} and which is provided to the second set of terminals of the stator as V_{S}.

11. The system of claim 10, wherein V_{R} is applied to the rotor in a first direction and V_{S} is applied to the stator in a second direction that is opposite the first direction so as to cause the production of torque between the rotor and stator.

12. The system of claim 10, wherein the drive circuit includes a variable frequency drive, a Voltage Source Inverter (VSI) inverter stage, a Current Source Inverter (CSI) inverter stage, a Z-Source Inverter (ZSI) inverter stage, a direct AC-AC converter stage, and/or one or more transformers.

13. An electrostatic machine system, comprising:
a rotor;
the rotor having at least one rotor plate;
the at least one rotor plate having a first plurality of electrodes positioned on the rotor plate;
the rotor having a first set of electric terminals;
wherein the first set of electric terminals are electrically connected to the first plurality of electrodes and are configured to facilitate application of a first multiphase AC drive voltage (V_{R}) to the first plurality of electrodes;
a stator;
the stator having at least one stator plate;
the at least one stator plate having a second plurality of electrodes positioned on the stator plate;
the stator having a second set of electric terminals;
wherein the second set of electric terminals are electrically connected to the second plurality of electrodes and are configured to facilitate application of a second multiphase AC drive voltage (V_{S}) to the second plurality of electrodes;
wherein in response to V_{R} being provided to the first set of electric terminals and V_{S} being provided to the second set of electric terminals, electric fields generated by the first set of electrodes and the second set of electrodes cause the production of torque between the rotor and stator.

14. The system of claim 13, wherein the first set of electric terminals of the rotor are configured to apply the V_{R} to the first plurality of electrodes of the rotor by applying each phase of V_{R} to a respective subset of the first plurality of electrodes.

15. The system of claim 13, wherein the second set of electric terminals of the stator is configured to apply the V_{S} to the second plurality of electrodes of the stator by applying each phase of V_{S} to a respective subset of the second plurality of electrodes.

16. The system of claim 13, wherein during operation V_{S} has a frequency equal to the sum of a frequency of V_{R} and a frequency of mechanical rotation of the rotor.

17. The system of claim 13, further comprising a multiphase drive system configured to generate V_{R} and V_{S}.

18. The system of claim 13, further comprising a multiphase drive system;
the multiphase drive system including a first drive circuit configured to generate V_{R} and a second drive circuit configured to generate V_{S}.

19. The system of claim 13, further comprising a multiphase drive system;
the multiphase drive system including a first drive circuit configured to generate V_{R} and a second drive circuit configured to generate V_{S};
wherein the first drive circuit and the second drive circuit are variable frequency drives, each comprising voltage source inverters, current source inverters, Z-source inverters or direct AC-AC converters.

20. The system of claim 13, further comprising a multiphase drive system;
wherein the multiphase drive system includes a variable frequency drive configured to generate a first AC voltage and a second variable frequency drive configured to generate a second AC voltage.

21. The system of claim 13, further comprising a multiphase drive system;
wherein the multiphase drive system includes a variable frequency drive configured to generate a first AC voltage;
wherein the multiphase drive system includes a second variable frequency drive configured to generate a second AC voltage;
wherein the multiphase drive system includes a first transformer circuit configured to boost to the first AC voltage;
wherein the multiphase drive system includes a second transformer circuit configured to boost to the second AC voltage.

22. The system of claim 13, further comprising:
a multiphase drive system configured to generate a first AC signal and a second AC signal;
one or more multiphase transformers configured to generate the multiple phases of V_{R} from the first AC signal and generate the multiple phases of V_{S} from the second AC signal.

23. The system of claim 13, further comprising a coating formed on the first plurality of electrodes and the second plurality of electrodes;
wherein the coating is configured to inhibit electrochemical reactions with the first plurality of electrodes and/or the second plurality of electrodes.

24. The system of claim 13, further comprising a coating formed on the first plurality of electrodes and the second plurality of electrodes;
wherein the coating is configured to inhibit corrosion of the first plurality of electrodes, corrosion of the second plurality of electrodes, and/or contamination of the dielectric fluid.

25. The system of claim 13, further comprising a parylene coating formed on the first plurality of electrodes and/or the second plurality of electrodes.

26. The system of claim 13, further comprising a multiphase drive system;
the multiphase drive system including a first drive circuit configured to generate V_{R} and a second drive circuit configured to generate V_{S};
wherein the first drive circuit is configured to generate V_{R} with a fixed frequency;
wherein the second drive circuit is configured to permit frequency of V_{S} to be adjusted.

27. The system of claim 13, further comprising a multiphase drive system;
the multiphase drive system including a first drive circuit configured to generate V_{R} and a second drive circuit configured to generate V_{S};
wherein the first drive circuit is configured to permit frequency of V_{R} to be adjusted;
wherein the second drive circuit is configured to generate V_{S} with a fixed frequency.

28. The system of claim 13, further comprising a multiphase drive system;
wherein the multiphase drive system is configured to permit frequency of V_{R} to be adjusted;
wherein V_{S} is provided from a fixed frequency power source.

29. The system of claim 13, further comprising a multiphase drive system;
wherein the multiphase drive system is configured to permit frequency of V_{S} to be adjusted;
wherein V_{R} is provided from a fixed frequency power source.
